(19) United States
(12) Patent Application Publication
(10) Pub. No.: US 2025/0171243 A1
(43) Pub. Date: May 29, 2025

(54) A CASSETTE LOGISTICS SYSTEM

(71) Applicant: CORNING INCORPORATED, CORNING, NY (US)

(72) Inventors: Xu Cao, Hebei (CN); Jun Gu, Shanghai (CN); Jun Yuan Hou, Tainan City South District (TW)

(21) Appl. No.: 18/837,514

(22) PCT Filed: Mar. 7, 2023
(86) PCT No.: PCT/US2023/014707

§ 371 Date: Aug. 9, 2024

(30) Foreign Application Priority Data
Mar. 9, 2022 (CN) 202220514889.5

(51) Int. Cl. B65G 45/22; B65G 1/04

(52) U.S. Cl. CPC B65G 45/22; B65G 1/04; B65G 2203/0208; B65G 2203/042

(57) ABSTRACT

The disclosure relates to a new cassette logistics system comprising a conveyor to transfer a cassette and a cleaning and measuring station. The conveyor is configured to moves the cassette in a first direction. The cleaning and measuring station is positioned at a location along the conveyor such that the cassette is received at the cleaning and measurement station when the cassette has moved a predetermined distance in the first direction. The cleaning and measuring station has both a cleaning port and a measurement port. The cleaning port is configured to removed debris on surfaces of the cassette and the measurement port is configured to measure contents of the cassette after the debris has been removed.

### CROSS REFERENCE TO RELATED APPLICATION

This application claims the benefit of priority under 35 U.S.C. § 119 of Chinese Patent Application Serial No.: 202220514889.5 filed on Mar. 9, 2022, the content of which is relied upon and incorporated herein by reference in its entirety.

### TECHNICAL FIELD

The disclosure relates to a cassette logistics system and more particularly to a cassette logistics system with a unique cleaning and measuring arrangement, as may be used in a flat panel display manufacturing process.

### BACKGROUND

A Cassette Logistics System (CLS) is an automated storage and retrieval system. Applicants may use to transfer cassettes with glass sheets back and forth between different locations, such as between display panel manufacturers and display glass manufacturers. For example, fully packed cassettes may transfer to display panel manufacturers when production orders are received. Empty cassettes may return to display glass manufacturers periodically.

A CLS may, for example, possess several functional ports to support cassette transportation and inspection, two of which are a cleaning port and a measurement port. A cleaning port may be for cassette cleaning and a measurement port may be for cassette measurement to make sure cassette status is good before glass packing.

At the cleaning port, the air knives may be used to create a strong uniform airflow along blades of the air knives and corresponding exhaust ring blowers may be equipped to extract the air, thus dust/particles attached to a cassette may be removed. After cleaning through such air knives in the cleaning port, a cassette may be transferred by conveyor to a measurement port. However, Applicants have found that vibration of air knives and exhaust fans of the cleaning port may be transmitted to nearby equipment, resulting in vibration of the measurement port, thereby affecting measurement accuracy. So those of skill in the art may expect such cleaning and measurement ports to be spaced apart and separated. However, in such arrangements, since the cleaning port and the measurement port are in different stations for vibration isolation, such a design results in a large footprint. Thus, there is a need for an improved cassette logistics system with a smaller footprint and capable of providing more accurate measurements.

### SUMMARY

One of the objects of the exemplary embodiments of the disclosure is to overcome the above and other drawbacks existing in the prior art.

In accordance with the present disclosure, there is provided a new cassette logistics system comprising a conveyor to transfer a cassette and a cleaning and measuring station. The conveyor is configured to moves the cassette in a first direction. The cleaning and measuring station is positioned at a location along the conveyor such that the cassette is received at the cleaning and measurement station when the cassette has moved a predetermined distance in the first direction. The cleaning and measuring station has both a cleaning port and a measurement port such that the cassette, when the cleaning port is configured to removed debris on surfaces of the cassette and the measurement port is configured to measure contents of the cassette after the debris has been removed.

According to some embodiments, the measurement port comprises plurality of frame sensors and a plurality of wire sensors.

According to some embodiments, the plurality of frame sensors is positioned at the corners of the cleaning and measurement station.

According to some embodiments, the plurality of wire sensors is positioned at the frame of the cleaning and measurement station to monitor the status of the wires within the cassette.

According to some embodiments, the cleaning port comprises a plurality of air knives.

According to some embodiments, the cleaning and measurement station further comprises a lifter conveyor.

In another aspect of the disclosure, there is provide a method of conveying a cassette in a logistics system comprising: first, receiving a cassette to at an cleaning and measuring station, wherein the cleaning and measuring station comprises both a cleaning port and a measurement port; second, cleaning the cassette at the cleaning port; third, moving the cassette to the measurement port through a lifter conveyor; and fourth, measuring the cassette at the measuring port.

According to some embodiments, when the cassette is measured the cleaning port is not cleaning another cassette.

According to some embodiments, the cleaning port is not vibrating during the measuring.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary and are intended to provide an overview or framework to understand the nature and character of the claims.

### BRIEF DESCRIPTION OF THE FIGURES

The accompanying Figures are included to provide a further understanding and are incorporated in and constitute a part of this specification. The drawings illustrate one or more embodiments, and together with the Detailed Description explain principles and operations of the various embodiments. As such, the disclosure will become more fully understood from the following Detailed Description, taken in conjunction with the accompanying Figures, in which:

FIG. 1 is a schematic view of the Cassette Logistics System (CLS) according to one an embodiment.

FIG. 2 is a schematic perspective view of a typical empty cassette used in display glass manufacturing facilities according to an embodiment.

FIG. 3 is a schematic front view of empty cassette used in display glass manufacturing facilities.

FIG. 4 is a schematic top view of a cleaning and measurement station with air knifes and measurement sensors.

FIG. 5 is a schematic view of the related position of air knife and ring blower in the cleaning port.

### DETAILED DESCRIPTION

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

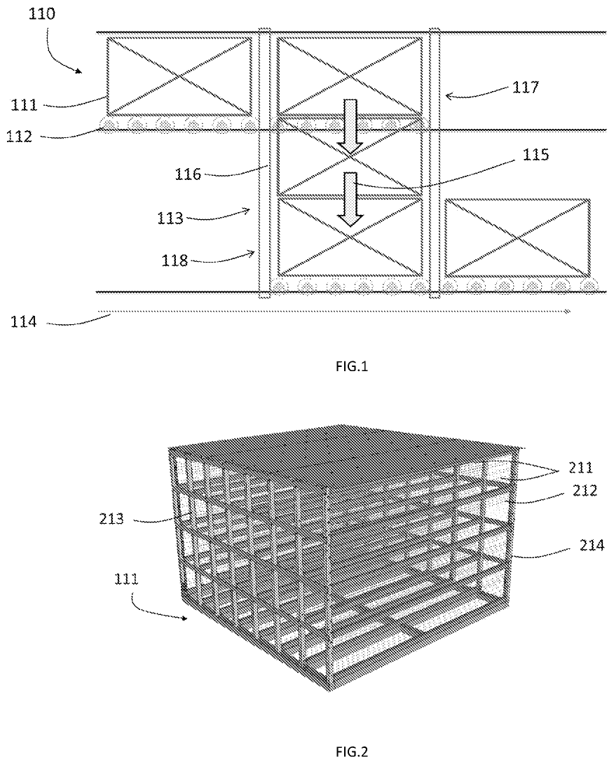

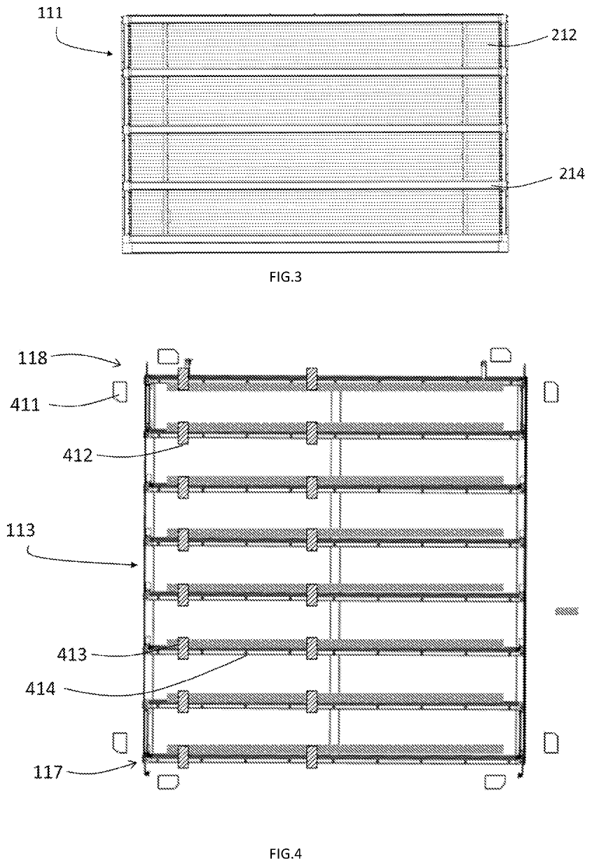

Referring more particularly to the drawings, FIG. 1 presents a schematic illustration of a representative Cassette Logistics System (CLS) 110. Cassettes 111 are used to transfer glass sheets (not shown in the figures) back and forth between different locations, such as between display panel manufacturers and display glass manufacturers. According to an exemplary embodiment, FIG. 2 is a schematic perspective view of a typical empty cassette 111 used in display glass manufacturing facilities. The cassette 111 could store fifty pieces of glass sheets with the structure of fifty wires slots 211. There are eight sets of wire frames 213 in each cassette 111, which means four hundred wires 212 in total. It can be seen there are five beams 214 in total from the cassette 111 front view. Referring to FIG. 2, the fifty wire slots 211 are divided into four groups by the beams 214, with twelve-or thirteen-pieces capacity of glass sheets in separate.

Referring to FIG. 1, A CLS 110 may, for example, possess several functional ports to support cassette 111 transportation and inspection, according to some embodiment, CLS 110 comprises a conveyor 112 to transfer a cassette 111. The conveyor 112 is configured to moves the cassette 111 in a first direction 114. A cleaning and measuring station 113 that is positioned at a location along the conveyor 112 such that the cassette 111 is received at the cleaning and measurement station 113 when the cassette 111 has moved a predetermined distance in the first direction 114. The cleaning and measuring station 113 has both a cleaning port 117 and a measurement port 118, the cleaning port 117 is configured to removed debris on surfaces of the cassette 111 and the measurement port 118 is configured to measure contents of the cassette 111 after the debris has been removed. According to some embodiment, the cleaning and measurement station 113 further comprises a lifter conveyor 116. The lifter conveyor 116 can lift the cassette 111 in a second direction 115. According to some embodiments, the lifter conveyor 116 could move the cassette 111 upwards and downwards.

According to some embodiments, a method of conveying a cassette 111 in a logistics system 110, comprises: 1) receiving a cassette 111 to at the cleaning and measuring station 113 which comprises both a cleaning port 117 and a measurement port 118; 2) cleaning the cassette 111 at the cleaning port 117; 3) moving the cassette 111 to the measurement port 118 through the lifter conveyor 116; 4) measuring the cassette 111 at the measuring port 118. According to some embodiments, when the cassette 111 is measured the cleaning port 117 is not cleaning another cassette 111. According to some embodiments, the cleaning port 117 is not vibrating during the measuring.

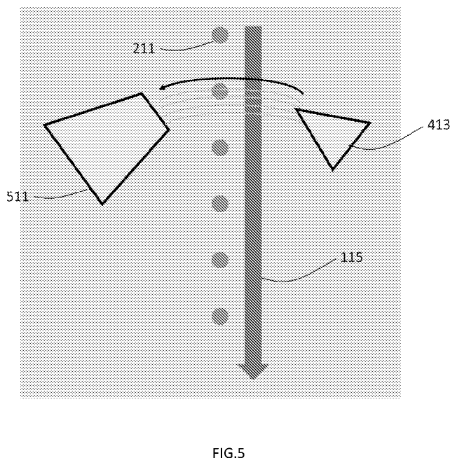

As shown in FIG. 4, two types of sensors are installed on the measurement port 118. One is frame sensor 411 mainly used for cassette tilt monitoring, and the other is wire sensor 412 for wire slackness detection. The plurality of frame sensors 411 could be positioned at the corners of the cleaning and measurement station 113. According to some embodiments, the frame sensors 411 are placed in the four corners of measurement port 118. Each corner possesses two frame sensors 411 to measure data in X and Y directions separately. According to some embodiments, the frame sensors' 411 laser head are analog type. Wire sensors could be installed in the frame of the cleaning and measurement station 113. According to some embodiments, the plurality of wire sensors 412 is positioned at the frame of the cleaning and measurement station 414 to monitor wire 212 status. As shown in FIG. 4, eight sets of wire sensors 412 are applied to measure the status of wire slots 211 and beam-wire gap. In each set of wire sensors 412, one wire sensor 412 could be installed at the edge of the frame of the cleaning and measurement station 113, while the other wire sensor 412 could be installed near the middle of the frame of the cleaning and measurement station 113.

The cleaning port 117 comprises a plurality of air knives 413. The air knives 413 could be installed in the frames 414 of port which are in parallel with wire frames 213 of the cassette 111. The air knife 413 is used to create a strong uniform airflow along blades of the air knife 413 and a corresponding ring blower 511 may be equipped to extract the air, thus dust/particles attached on the wires 211 may be removed. FIG. 5 presents a schematic view of the related position of an air knife 413 and a ring blower 511 in the cleaning port 117. According to some embodiments, there are eight sets of air knives 413 and correspond ring blower 511 as there are eight sets of wire frames 213 in the cassette 111.

What is claimed is:

1. A cassette logistics system, comprising:
a conveyor to transfer a cassette, wherein the conveyor is configured to move the cassette in a first direction;
a cleaning and measuring station positioned at a location along the conveyor such that the cassette is received at the cleaning and measurement station when the cassette has moved a predetermined distance in the first direction;
wherein the cleaning and measuring station has both a cleaning port and a measurement port, and wherein the cleaning port is configured to remove debris on surfaces of the cassette and the measurement port is configured to measure contents of the cassette after the debris has been removed.

2. The cassette logistics system of claim 1, wherein the measurement port comprises plurality of frame sensors and a plurality of wire sensors.

3. The cassette logistics system of claim 2, wherein the plurality of frame sensors is positioned at corners of the cleaning and measurement station.

4. The cassette logistics system of claim 2, wherein the plurality of wire sensors is positioned at a frame of the cleaning and measurement station to monitor the status of wires within the cassette.

5. The cassette logistics system of claim 1, wherein the cleaning port comprises a plurality of air knives.

6. The cassette logistics system of claim 1, wherein the cleaning and measurement station further comprises a lifter conveyor.
